(19) United States
(12) Patent Application Publication
(10) Pub. No.: US 2012/0153724 A1
(43) Pub. Date: Jun. 21, 2012

(54) POWER-GENERATION CONTROL APPARATUS, POWER-GENERATION CONTROL METHOD AND POWER GENERATION SYSTEM

(75) Inventors: Hiroshi Hasegawa, Kanagawa (JP); Atsushi Sato, Kanagawa (JP); Yoshiaki Inoue, Aichi (JP)

(73) Assignee: Sony Corporation, Tokyo (JP)

(21) Appl. No.: 13/323,942

(22) Filed: Dec. 13, 2011

(30) Foreign Application Priority Data
Dec. 21, 2010 (JP) 2010-284366

(51) Int. Cl. H02J 7/34

(52) U.S. Cl. 307/31

(57) ABSTRACT

Disclosed herein is a power generation control apparatus including: a power generation efficiency control section configured to control the power generation efficiency of a power generation module for generating electric power in accordance with light received by the power generation module; and a power accumulation control section configured to control power accumulation into the power accumulation section accumulating electric power generated by the power generation module by detecting the power accumulation state of the power accumulation section. When the power generation module is in a state of being capable of generating electric power and if the power accumulation section is in a state of having fully accumulated electric power and if a load connected to the power accumulation section is in a state of consuming no electric power, the power generation efficiency control section controls the power generation module to generate electric power at a low power generation efficiency.

### BACKGROUND

The present disclosure relates to an electric power generation control apparatus, an electric power generation control method and an electric power generation system. More particularly, the present disclosure relates to an electric power generation control apparatus capable of properly restraining generation of surplus electric power, an electric power-generation control method for the apparatus and an electric power generation system including the apparatus.

In the past, in an electric power generation system configured to employ a solar battery and a secondary battery to serve as a hybrid system, electric power generated by the solar battery was supplied directly to equipments and electric power generated by the solar battery and temporarily accumulated in the secondary battery was also eventually supplied to the equipments.

Normally, the amount of electric power generated by a solar battery depends on, among others, an environment in which the solar battery is installed. In this case, the environment includes the state in which sunlight is radiated to a place at which the solar battery is installed. In addition, the state in which electric power is accumulated in a secondary battery and discharged from the secondary battery depends on the frequency at which the equipment is used and an environment in which the equipment is used. Thus, there is no correlation between the amount of electric power generated by the solar battery and the state in which electric power is accumulated in a secondary battery and discharged from the secondary battery.

Accordingly, it is reasonable to assume a typical situation in which no electric power is generated by the solar battery because no light such as sunlight is radiated to the solar battery and the amount of electric power discharged from the secondary battery is large because the equipment is used frequently. In such a situation, electric power output by a home battery or the like is accumulated in the secondary battery and, then, supplied to the equipment.

On the other hand, it is also reasonable to assume another typical situation in which the solar battery generates electric power because light such as direct daylight is radiated to the solar battery but electric power does not have to be newly accumulated in the secondary battery because sufficient electric power has been accumulated therein. In such a situation, the states of the solar and secondary batteries are generally sustained as they are. That is to say, in spite of the fact that the solar battery is generating electric power, the generated electric power cannot be output.

Depending on the type of the solar battery, the situation in which the solar battery cannot output electric power generated thereby is not desirable. In order to solve this problem, there has been proposed a method for converting the surplus electric power, which has been generated by a solar battery but cannot be output, into heat by making use of a resistor or the like and dissipating the heat. In the following description, the surplus electric power, which has been generated by a solar battery but cannot be output, is properly referred to simply as surplus electric power.

In addition, Japanese Patent Laid-open No. 2003-87993 (referred to as Patent Document 1 hereinafter) discloses a proposed method for controlling generation of surplus electric power by shorting the output of the solar battery without making use of a resistor for discarding the surplus electric power.

### SUMMARY

However, even though the proposed method disclosed in Patent Document 1 can be considered to be conceptually effective, there is a high risk caused by shorting the output of the solar battery so that the method is not realistic. Thus, there is a demand for proper control of the surplus electric power.

It is thus a desire of the present disclosure, which addresses the problems described above, to properly control the surplus electric power.

According to an embodiment of the present disclosure, there is a power generation control apparatus including a power generation efficiency control section configured to control the power generation efficiency of a power generation module for generating electric power in accordance with light received by the power generation module, and a power accumulation control section configured to control power accumulation into the power accumulation section accumulating electric power generated by the power generation module by detecting the power accumulation state of the power accumulation section. When the power generation module is in a state of being capable of generating electric power and if the power accumulation section is in a state of having fully accumulated electric power and if a load connected to the power accumulation section is in a state of consuming no electric power, the power generation efficiency control section controls the power generation module to generate electric power at a low power generation efficiency.

According to another embodiment of the present disclosure, there is a power generation control method including: controlling the power generation efficiency of a power generation module generating electric power in accordance with light received; and controlling power accumulation into a power accumulation section accumulating electric power generated by the power generation module by detecting the power accumulation state of the power accumulation section. When the power generation module is in a state of being capable of generating electric power and if the power accumulation section is in a state of having fully accumulated electric power and if a load connected to the power accumulation section is in a state of consuming no electric power, the power generation module is controlled to generate electric power at a low power generation efficiency.

According to further embodiment of the present disclosure, there is a power generation system including: a power generation module configured to generate electric power in accordance with light received; a power accumulation section configured to accumulate electric power generated by the power generation module; a power generation efficiency control section configured to control the power generation efficiency of the power generation module; and a power accumulation control section configured to control power accumulation into the power accumulation section by detecting the power accumulation state of the power accumulation section. When the power generation module is in a state of being capable of generating electric power and if the power accumulation section is in a state of having fully accumulated electric power and if a load connected to the power accumulation section is in a state of consuming no electric power, the power generation efficiency control section controls the power generation module to generate electric power at a low power generation efficiency.

In accordance with the embodiments of the present disclosure, the power generation efficiency of a power generation module for generating electric power in accordance with light received is controlled, and power accumulation into a power accumulation section for accumulating electric power generated by the power generation module is controlled by detecting the power accumulation state of the power accumulation section.

In addition, when the power generation module is in a state of being capable of generating electric power and if the power accumulation section is in a state of having fully accumulated electric power and if a load connected to the power accumulation section is in a state of consuming no electric power, the power generation module is controlled to generate electric power at a low power generation efficiency.

In accordance with the embodiments of the present disclosure, generation of surplus electric power can be properly controlled.

### BRIEF DESCRIPTION OF THE DRAWINGS

FIG. 1 is a block diagram showing a typical configuration of an embodiment implementing a power generation system to which the present disclosure is applied;

FIG. 2 is a diagram showing voltage-current characteristics of a solar power generation module employed in the power generation system shown in FIG. 1;

FIG. 3 is a diagram showing a conversion efficiency characteristic of a boost DC/DC converter employed in the power generation system shown in FIG. 1; and

FIG. 4 shows an explanatory flowchart representing processing to control electric power generated by the solar power generation module.

### DETAILED DESCRIPTION OF THE PREFERRED EMBODIMENT

By referring to the diagrams, the following description explains details of a concrete embodiment implementing the present disclosure.

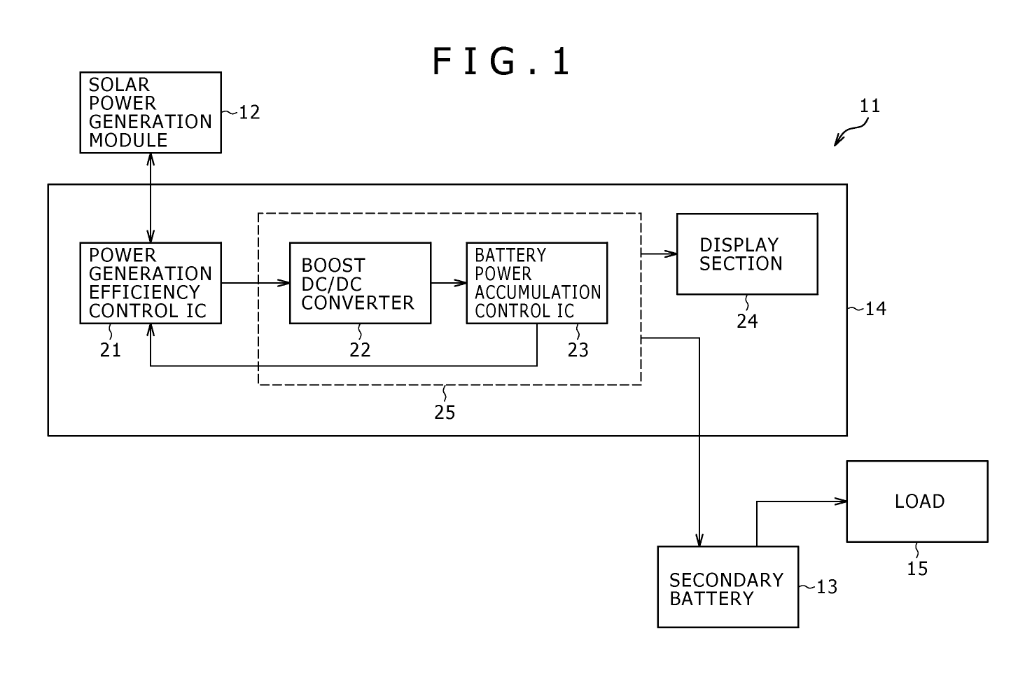

FIG. 1 is a block diagram showing a typical configuration of the embodiment implementing a power generation system 11 to which the present disclosure is applied.

As shown in FIG. 1, the power generation system 11 employs a solar power generation module 12, a secondary battery 13 and a power generation control apparatus 14. Electric power generated by the power generation system 11 is consumed by a load 15 connected to the secondary battery 13. The load 15 is composed of typically a variety of electrical apparatus.

The solar power generation module 12 is configured to typically employ a plurality of cells for generating electric power in accordance with radiation of sunlight to the solar power generation module 12. The cell is a solar battery device. To be more specific, the cell is typically a dye-sensitized solar battery making use of an organic pigment.

The dye-sensitized solar battery has a structure in which an electrolyte layer is provided between a titania multihole electrode supported by a sensitizing dye and a counterpart electrode. In the case of a dye-sensitized solar battery making use of an electrolyte liquid including a redox pair (such as I⁻ and I₃₋) as an electrolyte layer for example, light hitting the titania multihole electrode at a power-generation time during the day is absorbed by the sensitizing dye which then discharges electrons into the titania multihole electrode. At that time, holes left in the sensitizing dye oxidize iodide ions (I⁻), changing the iodide ions (I⁻) into tri-iodide ions (I₃⁻). In addition, the electrons discharged into the titania multihole electrode migrate to the counterpart electrode through a circuit and, at the same time, reduce tri-iodide ions (I₃⁻) in the counterpart electrode, changing the tri-iodide ions (I₃⁻) to iodide ions (I⁻). Then, this cycle occurs continuously so that light energy is converted into electrical energy.

It is to be noted that the solar power generation module 12 can be configured to employ cells which are typically crystalline-silicon solar batteries making use of a single-crystal or multi-crystal silicon and amorphous-silicon solar batteries.

The secondary battery 13 is typically configured as a lithium-ion secondary battery. In accordance with control carried out by the power generation control apparatus 14, the secondary battery 13 accumulates electric power generated by the solar power generation module 12 and supplies the accumulated electric power to the load 15.

The power generation control apparatus 14 is an apparatus for controlling the power generation efficiency of the solar power generation module 12 and the accumulation of electric power generated by the solar power generation module 12 in the secondary battery 13. Typically, the power generation control apparatus 14 employs a power generation efficiency control IC (Integrated Circuit) 21, a boost DC/DC (Direct Current/Direct Current) converter 22, a battery power accumulation control IC 23 and a display section 24.

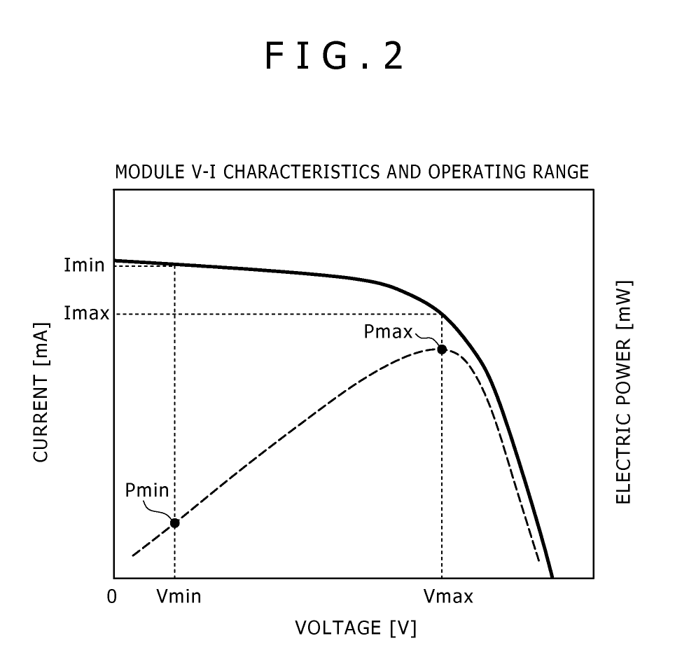

The power generation efficiency control IC 21 is an IC for receiving electric power generated by the solar power generation module 12. The power generation efficiency control IC 21 typically adopts a control method such as the MPPT (Maximum Power Point Tracker) control method in order to control the power generation efficiency of the solar power generation module 12. In addition, as will be explained later by referring to FIG. 2, the power generation efficiency control IC 21 changes the control method for controlling the power generation efficiency of the solar power generation module 12 in order to restrain the generation of surplus electric power by the solar power generation module 12 in accordance with, among others, the power accumulation state of the secondary battery 13.

The boost DC/DC converter 22 is a section for receiving electric power in the form of a voltage, which is changed in accordance with control carried out by the power generation efficiency control IC 21 to control the power generation efficiency of the solar power generation module 12, from the power generation efficiency control IC 21. The boost DC/DC converter 22 boosts the received voltage to a prescribed voltage required in accumulation of electric power in the secondary battery 13. The boost DC/DC converter 22 supplies the electric power boosted thereby to the secondary battery 13 by way of the battery power accumulation control IC 23 to be accumulated in the secondary battery 13. In addition, some of the electric power boosted by the boost DC/DC converter 22 is also consumed in operations to drive the sections employed in the power generation control apparatus 14.

The battery power accumulation control IC 23 controls an operation to accumulate the electric power boosted by the boost DC/DC converter 22 in the secondary battery 13. For example, the battery power accumulation control IC 23 detects the amount of electric power already accumulated in the secondary battery 13 and adjusts the amount of electric power being supplied to the secondary battery 13 so that electric power is accumulated in the secondary battery 13 properly in accordance with the detected amount of electric power already accumulated in the secondary battery 13.

In addition, when the solar power generation module 12 is receiving sunlight and generating electric power from the received sunlight, the battery power accumulation control IC 23 also determines whether or not the secondary battery 13 is in a state of having completed an operation to accumulate electric power and whether or not the load 15 is in a state of consuming no electric power. In the following description, the state in which the load 15 is not consuming electric power is referred to simply as a non-consumption state of the power generation system 11. If the battery power accumulation control IC 23 detects the non-consumption state of the power generation system 11, the battery power accumulation control IC 23 notifies the power generation efficiency control IC 21 that the load 15 is not consuming electric power. Notified of the non-consumption state, the power generation efficiency control IC 21 changes the method for controlling the power generation efficiency of the solar power generation module 12.

The display section 24 is configured to have typically an LED and the like. The display section 24 displays the operating state of the power generation system 11 or the like by turning on the LED. Thus, the power generation control apparatus 14 is configured to have the display section 24 consume electric power determined in advance.

In the power generation system 11 having the configuration described above, if the battery power accumulation control IC 23 determines that the power generation system 11 is in a non-consumption state, the battery power accumulation control IC 23 notifies the power generation efficiency control IC 21 of the non-consumption state and, the power generation efficiency control IC 21 changes the method for controlling the power generation efficiency of the solar power generation module 12 in order to restrain generation of surplus electric power. It is to be noted that the boost DC/DC converter 22 and the battery power accumulation control IC 23 which are employed in the power generation control apparatus 14 can be configured by integrating the boost DC/DC converter 22 and the battery power accumulation control IC 23 into typically an integrated IC 25.

Next, by referring to FIG. 2, the following description explains the method for controlling the power generation efficiency of the power generation efficiency control IC 21. FIG. 2 is a diagram showing voltage-current characteristics of the solar power generation module 12 shown in FIG. 1. In the figure, the voltage-current characteristics are referred to as module V-I characteristics.

In FIG. 2, the horizontal axis represents the voltage output by the solar power generation module 12 whereas the vertical axis on the left side represents the current output by the solar power generation module 12. A curve shown as a solid line in FIG. 2 represents a voltage-current characteristic of electric power output by the solar power generation module 12. The vertical axis on the right side in FIG. 2 represents the electric power output by the solar power generation module 12. A curve shown as a dashed line in FIG. 2 represents a characteristic of the electric power output by the solar power generation module 12.

As explained before, when the solar power generation module 12 is receiving sunlight and generating electric power from the received sunlight, the battery power accumulation control IC 23 determines whether or not the power generation system 11 is in a non-consumption state. If the battery power accumulation control IC 23 determines that the power generation system 11 is in a non-consumption state, the battery power accumulation control IC 23 notifies the power generation efficiency control IC 21 of the non-consumption state, and the power generation efficiency control IC 21 changes the method for controlling the power generation efficiency of the solar power generation module 12.

For example, the power generation system 11 is not in a non-consumption state. That is to say, electric power is being accumulated in the secondary battery 13 or being supplied to the load 15 through the secondary battery 13. In this case, the power generation efficiency control IC 21 carries out MPPT control to track a maximum output point Pmax on the curve, which is represented by the dashed line in FIG. 2, in accordance with, among others, changes of the voltage-current characteristic of the solar power generation module 12 and changes of the amount of electric power consumed by the load 15. That is to say, in this case, the power generation efficiency control IC 21 controls the solar power generation module 12 so that the solar power generation module 12 outputs electric power corresponding to the maximum output point Pmax. As shown in FIG. 2, electric power corresponding to the maximum output point Pmax is electric power generated at a current Imax and a voltage Vmax which prescribe a point on the curve represented by the solid line in FIG. 2.

If the power generation system 11 is in a non-consumption state, on the other hand, the power generation efficiency control IC 21 carries out control to track a minimum output point Pmin on the curve, which is represented by the dashed line in FIG. 2, in accordance with changes of the voltage-current characteristic of the solar power generation module 12. That is to say, in this case, the power generation efficiency control IC 21 controls the solar power generation module 12 so that the solar power generation module 12 outputs electric power corresponding to the minimum output point Pmin. As shown in FIG. 2, electric power corresponding to the minimum output point Pmin is electric power generated at a current Imin and a voltage Vmin which prescribe a point on the curve represented by the solid line in FIG. 2.

The electric power corresponding to the minimum output point Pmin is minimum electric power required in operations to drive the sections included in the power generation control apparatus 14. The power generation control apparatus 14 requires electric power including specific electric power consumed in an operation to turn on the LED of the display section 24 and other specific electric power consumed in an operation to operate an operation section not shown in FIG. 1. The power generation efficiency control IC 21 controls the solar power generation module 12 so that the solar power generation module 12 outputs the required electric power at the minimum output point Pmin to maintain the electric power required in these operations.

In addition, when the power generation efficiency control IC 21 controls the power generation efficiency of the solar power generation module 12 so that the solar power generation module 12 outputs electric power at the minimum output point Pmin, as is obvious from the voltage-current characteristic shown in FIG. 2, the solar power generation module 12 is driven to operate at a low power generation efficiency or in a state in which the power generation efficiency is lowered.

As described above, when the power generation system 11 is in a non-consumption state, electric power generated by the solar power generation module 12 is consumed inside the power generation control apparatus 14 in the power generation system 11. In this way, generation of surplus electric power can be properly restrained.

In addition, the power generation efficiency control IC 21 determines the minimum output point Pmin on the basis of not only electric power output by the solar power generation module 12 itself. As a matter of fact, the power generation efficiency control IC 21 is capable of determining the minimum output point Pmin by also taking the conversion efficiency of the boost DC/DC converter 22 into consideration as follows.

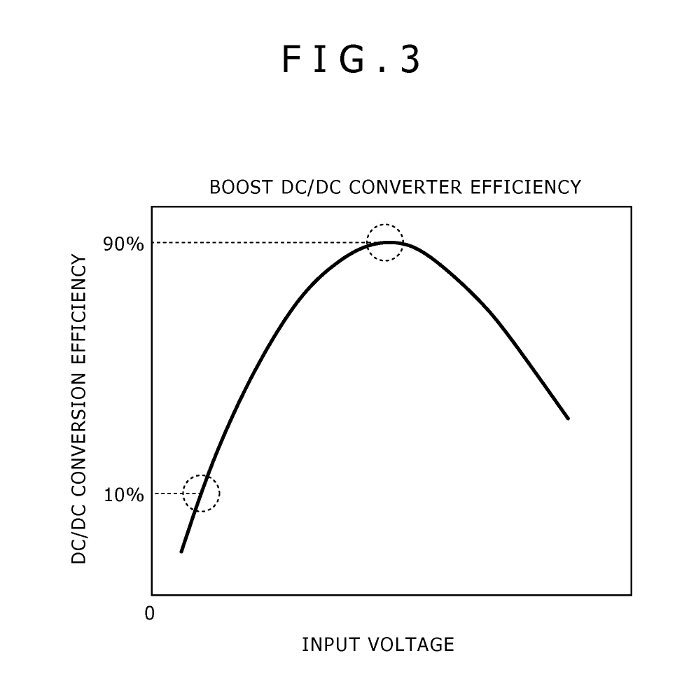

FIG. 3 is a diagram showing a conversion efficiency characteristic of the boost DC/DC converter 22 employed in the power generation system shown in FIG. 1. In FIG. 3, the horizontal axis represents an input voltage supplied to the boost DC/DC converter 22 whereas the vertical axis represents the conversion efficiency of the boost DC/DC converter 22.

As shown in FIG. 3, the boost DC/DC converter 22 displays performance having typically a maximum conversion efficiency of 90%. The conversion efficiency of the boost DC/DC converter 22 is represented by a curve having an upward protruding shape with a maximum point (or a peak point) corresponding to the maximum conversion efficiency of 90%. That is to say, in the boost DC/DC converter 22, a difference between an input voltage resulting in the maximum conversion efficiency and the output voltage is prescribed. If the difference is too large, the conversion efficiency decreases considerably.

Making use of such a decrease of the conversion efficiency, the power generation efficiency control IC 21 determines the minimum output point Pmin. For example, if an electric power corresponding to an input voltage resulting in a conversion efficiency of 10% is to be supplied to the boost DC/DC converter 22 and the LED of the display section 24 is driven by 10 mA/3.3 V, it is necessary to supply an electric power of 300 mW to the boost DC/DC converter 22. Thus, in this case, the power generation efficiency control IC 21 determines 300 mW as the minimum output point Pmin and controls the voltage and the current which are output by the solar power generation module 12.

By supplying an input voltage resulting in a decrease in conversion efficiency to the boost DC/DC converter 22 as described above, in the typical characteristic shown in FIG. 3 as a characteristic having a maximum conversion efficiency of 90%, the input voltage is converted into an output voltage at a conversion efficiency of 10%. Thus, the electric power generated by the solar power generation module 12 can be consumed by a small load to be borne in an operation to turn on the LED of the display section 24 and the like.

That is to say, it is possible to adopt a method for reducing the power generation efficiency of the solar power generation module 12 and effectively restrain generation of the surplus electric power in the boost DC/DC converter 22.

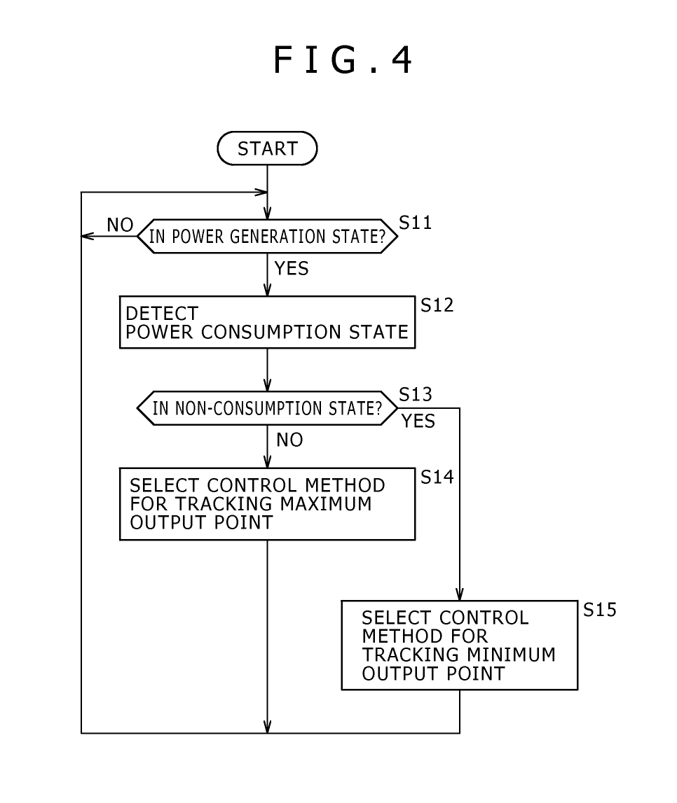

FIG. 4 shows an explanatory flowchart representing processing carried out by the power generation control apparatus 14 to control electric power generated by the solar power generation module 12.

As shown in the figure, the flowchart begins with a step S11 at which the power generation efficiency control IC 21 determines whether or not the solar power generation module 12 is in a state of generating electric power from sunlight radiated to the solar power generation module 12. If the power generation efficiency control IC 21 determines at the step S11 that the solar power generation module 12 is not in a state of generating electric power from sunlight radiated to the solar power generation module 12, the flow of the processing goes back to the step S11 to repeat the determination process of the step S11. The power generation efficiency control IC 21 determines that the solar power generation module 12 is in a state of generating electric power from sunlight radiated to the solar power generation module 12 by typically detecting electric power supplied from the solar power generation module 12.

As the power generation efficiency control IC 21 determines at the step S11 that the solar power generation module 12 is in a state of generating electric power from sunlight radiated to the solar power generation module 12, the flow of the processing goes on to a step S12 at which the battery power accumulation control IC 23 detects a state of consuming electric power in the power generation system 11. That is to say, the battery power accumulation control IC 23 detects existence/nonexistence of a state of requiring electric power to be accumulated in the secondary battery 13 and existence/nonexistence of a state in which the load 15 is consuming electric power. Then, the battery power accumulation control IC 23 notifies the power generation efficiency control IC 21 of information on whether or not a state of consuming electric power exists in the power generation system 11. Subsequently, the flow of the processing goes on to the next step S13.

At the step S13, on the basis of the notification received from the battery power accumulation control IC 23 at the step S12, the power generation efficiency control IC 21 determines whether or not the power generation system 11 is in a non-consumption state.

If the power generation efficiency control IC 21 determines at the step S13 that the power generation system 11 is not in a non-consumption state, the flow of the processing goes on to a step S14. At the step S14, the power generation efficiency control IC 21 adopts the so-called MPPT control method which is a control method for tracking the maximum output point Pmax. To put it in detail, if the method currently adopted by the power generation efficiency control IC 21 as a method for controlling the power generation efficiency of the solar power generation module 12 is the control method for tracking the minimum output point Pmin, the power generation efficiency control IC 21 switches the control method from the control method for tracking the minimum output point Pmin to the control method for tracking the maximum output point Pmax. If the method currently adopted by the power generation efficiency control IC 21 as a method for controlling the power generation efficiency of the solar power generation module 12 is the control method for tracking the maximum output point Pmax, the power generation efficiency control IC 21 continues the control method for tracking the maximum output point Pmax as it is.

If the power generation efficiency control IC 21 determines at the step S13 that the power generation system 11 is in a non-consumption state, on the other hand, the flow of the processing goes on to a step S15. At the step S15, the power generation efficiency control IC 21 adopts the control method for tracking the minimum output point Pmin. To put it in detail, if the method currently adopted by the power generation efficiency control IC 21 as a method for controlling the power generation efficiency of the solar power generation module 12 is the control method for tracking the maximum output point Pmax, the power generation efficiency control IC 21 switches the control method from the control method for tracking the maximum output point Pmax to the control method for tracking the minimum output point Pmin. If the method currently adopted by the power generation efficiency control IC 21 as a method for controlling the power generation efficiency of the solar power generation module 12 is the control method for tracking the minimum output point Pmin, the power generation efficiency control IC 21 continues the control method for tracking the minimum output point Pmin as it is.

After the process of the step S14 or S15 has been completed, the flow of the processing goes back to the step S11 to repeat the processing thereafter.

As described above, if the power generation system 11 is in a non-consumption state, the power generation efficiency control IC 21 adopts the control method for tracking the minimum output point Pmin as a method for controlling the power generation efficiency of the solar power generation module 12 so that the solar power generation module 12 generates electric power consumed inside the power generation control apparatus 14. Thus, generation of surplus electric power can be restrained. That is to say, even if the power generation system 11 is in a non-consumption state, the solar power generation module 12 is not detached from the power generation system 11 and the output of the solar power generation module 12 is not shorted. Thus, it is possible to prevent the solar power generation module 12 from deteriorating and restrain generation of surplus electric power with a high degree of safety.

As a method for restraining generation of surplus electric power, for example, a method of opening the output of the solar battery is conceivable. In accordance with this method, however, in a dye-sensitized solar battery for example, polarization occurs, causing the characteristic of the battery to deteriorate or causing the opto-electrical conversion efficiency to decrease. In addition, as a method for restraining generation of surplus electric power, a method of shorting the output of the solar battery is also conceivable. In accordance with this method, however, it is feared that shorting the output of the solar battery entails a high risk.

In the case of the power generation system 11, on the other hand, the solar power generation module 12 can be controlled to generate electric power consumed inside the power generation control apparatus 14. Thus, it is possible to avoid a state in which the output of the solar power generation module 12 is shorted and, hence, possible to enhance the degree of safety. In addition, it is also possible to prevent polarization from occurring even in the case of a solar power generation module 12 composed of dye-sensitized solar batteries making use of an organic material and, hence, possible to restrain deteriorations more effectively.

In addition, in the case of the related-art power generation system, in a non-consumption state, surplus electric power generated by the solar-battery power generation module is discarded by making use of a device used for dissipating the surplus electric power. Typical examples of such a device are a transistor and a switching transistor. In the case of the power generation system 11, on the other hand, in a non-consumption state, the power generation efficiency control IC 21 is capable of controlling the power generation efficiency of the solar power generation module 12 so that the solar power generation module 12 generates electric power at a minimum output point P2. Thus, it is not necessary to provide the surplus-power dissipating device such as a resistor or a switching transistor. As a result, it is possible to prevent heat from being generated by the surplus-power dissipating device such as a resistor or a switching transistor and possible to get rid of bad effects caused by the heat on the secondary battery 13, the power generation system 11 and an apparatus employing the power generation system 11.

As described above, in the power generation system 11, in an environment in which the solar power generation module 12 generates electric power from sunlight radiated to the solar power generation module 12 and in a non-consumption state, it is possible to restrain deterioration of the solar power generation module 12. Thus, the power generation system 11 is capable of sustaining the power generation performance of the solar power generation module 12 and improving the reliability of the solar power generation module 12.

It is to be noted that the processes of the steps composing the flowchart described above do not have to be carried out along the time axis in the order according to the flowchart. Instead, the processes may include processes carried out concurrently in parallel processing or individually as object-oriented processes. In addition, the processes of the steps composing the flowchart described above cam be carried out as a program executed by a CPU (Central Processing Unit) or a plurality of CPUs in a distributed-processing environment.

On top of that, the technical term ‘system’ used in this specification of the present disclosure means the configuration of a combination including a plurality of apparatus.

It is to be noted that the series of processes described previously can be carried out by hardware and/or execution of software. If the series of processes described above is carried out by execution of software, programs composing the software can be installed into a computer embedded in dedicated hardware, a general-purpose computer or the like from typically a removable program recording medium. A general-purpose computer is a computer, which can be made capable of carrying out a variety of functions by installing a variety of programs into the computer.

In the computer, a CPU carries out various kinds of processing described above by execution of programs stored in a ROM (Read Only Memory) in advance or programs loaded from a storage section into a RAM (Random Access Memory). The storage section used for storing the programs in advance is typically a hard disc or a nonvolatile memory.

Instead of storing the programs in the storage section in advance, the programs can be installed in the storage section by downloading the programs from a network by way of a communication section employed in the computer to serve typically as a network interface. As another alternative, the programs can also be installed in the storage section from the removable program recording medium cited above by mounting the removable program recording medium onto a drive employed in the computer to serve as a section for driving the removable program recording medium. Typical examples of the removable program recording medium are a magnetic disc such as a flexible disc, an optical disc such as a CD-ROM (Compact Disk-Read Only Memory) or a DVD (Digital Versatile Disk), a magneto-optical disk such as an MD (Mini Disk) as well as a semiconductor memory.

It is to be noted that the programs executed by the computer to carry out the processing described above can be programs executed along the time axis in accordance with the order explained in this specification of the present disclosure or programs executed concurrently. As another alternative, the programs can also be programs executed with required timings such as program invocation timings. In addition, the programs can be carried out by a CPU or a plurality of CPUs in a distributed-processing environment.

It is to be noted that implementations of the present disclosure are by no means limited to the embodiment described above. That is to say, it is possible to make a variety of changes within the range of the technological concept of the present disclosure to the embodiment.

The present disclosure contains subject matter related to that disclosed in Japanese Priority Patent Application JP 2010-284366 filed in the Japan Patent Office on Dec. 21, 2010, the entire content of which is hereby incorporated by reference.

1. A power generation control apparatus comprising:
a power generation efficiency control section configured to control power generation efficiency of a power generation module for generating electric power in accordance with light received by said power generation module; and
a power accumulation control section configured to control power accumulation into said power accumulation section accumulating electric power generated by said power generation module by detecting the power accumulation state of said power accumulation section,
wherein, when said power generation module is in a state of being capable of generating electric power and if said power accumulation section is in a state of having fully accumulated electric power and if a load connected to said power accumulation section is in a state of consuming no electric power, said power generation efficiency control section controls said power generation module to generate electric power at a low power generation efficiency.

2. The power generation control apparatus according to claim 1,
wherein, when said power generation module is in a state of being capable of generating electric power and if said power accumulation section is in a state of having fully accumulated electric power and if a load connected to said power accumulation section is in a state of consuming no electric power, said power generation efficiency control section controls said power generation module to operate at such a power generation efficiency that said power generation module generates minimum electric power required for driving said power generation control apparatus.

3. The power generation control apparatus according to claim 1, further comprising:
a voltage conversion section configured to convert the voltage of electric power generated by said power generation module into a prescribed voltage required in accumulation of said electric power generated by said power generation module into said power accumulation section,
wherein minimum electric power required for driving said power generation control apparatus is found on the basis of the voltage-current characteristic of said power generation module and the conversion efficiency of said voltage conversion section.

4. A power generation control method comprising:
controlling power generation efficiency of a power generation module generating electric power in accordance with light received; and
controlling power accumulation into a power accumulation section accumulating electric power generated by said power generation module by detecting the power accumulation state of said power accumulation section,
wherein, when said power generation module is in a state of being capable of generating electric power and if said power accumulation section is in a state of having fully accumulated electric power and if a load connected to said power accumulation section is in a state of consuming no electric power, said power generation module is controlled to generate electric power at a low power generation efficiency.

5. A power generation system comprising:
a power generation module configured to generate electric power in accordance with light received;
a power accumulation section configured to accumulate electric power generated by said power generation module;
a power generation efficiency control section configured to control power generation efficiency of said power generation module; and
a power accumulation control section configured to control power accumulation into said power accumulation section by detecting the power accumulation state of said power accumulation section,
wherein, when said power generation module is in a state of being capable of generating electric power and if said power accumulation section is in a state of having fully accumulated electric power and if a load connected to said power accumulation section is in a state of consuming no electric power, said power generation efficiency control section controls said power generation module to generate electric power at a low power generation efficiency.
